(19) United States
(12) Patent Application Publication
(10) Pub. No.: US 2021/0380342 A1
(43) Pub. Date: Dec. 9, 2021

(54) Multi-Temperature Automated Storage, Retrieval and Delivery System

(71) Applicant: SencorpWhite, Inc., Hyannis, MA (US)

(72) Inventors: Brian Wright, Osterville, MA (US); Corey Calla, Marston Mills, MA (US); Robert Gordon, Quincy, MA (US); Kevin Hutchens, Sandwich, MA (US); Anthony Morocco, West Wareham, MA (US); Adam Kraft, Fairfield, OH (US); Scott Boyson, Leominster, MA (US)

(73) Assignee: SencorpWhite, Inc., Hyannis, MA (US)

(21) Appl. No.: 17/339,775

(22) Filed: Jun. 4, 2021

Related U.S. Application Data
(63) Continuation of application No. PCT/US2021/035960, filed on Jun. 4, 2021.
(60) Provisional application No. 63/034,825, filed on Jun. 4, 2020.

(51) Int. Cl. B65G 1/137

(52) U.S. Cl. CPC B65G 1/1375

(57) ABSTRACT

A multi-temperature, intelligent storage and retrieval system and methods to facilitate un-attended pick-up of orders by customers, which is particularly applicable to grocery purchases.

### CROSS REFERENCE TO RELATED APPLICATION

This application claims priority to U.S. Provisional Application No. 63/034,825, filed Jun. 4, 2020, entitled Multi-Temperature Automated Storage and Retrieval Machine and Delivery System and incorporated herein by reference, and is a continuation of International Application No. PCT/US2021/035960, filed Jun. 4, 2021, entitled Multi-Temperature, Automated Storage, Retrieval and Delivery System, incorporated herein by reference.

### FIELD

The present disclosure relates to automated storage and retrieval machines. In particular, the present disclosure relates to an automated storage and retrieval machine with multiple temperature zones.

### BACKGROUND

Retail establishments exist that provide pick-up bays to hold goods for customers to retrieve online orders. Pick-up bays are typically filled by store employees. Customers later retrieve their purchase by accessing the contents of a pick-up bay.

Online grocery ordering with in-store pick-up is becoming popular, however, traditional pick-up bays are often not large enough to provide enough storage space. Furthermore, they are not ergonomic for pick-up with al customer types.

Accordingly, there is a need for a pick-up system that allows customers to retrieve groceries without direct interaction with store personnel. There is a further need for an order pick-up system that allows customers to retrieve items without contact with surfaces, creating a touchless order pick-up opportunity. Additionally, there exists a need for the system to maintain grocery items or other purchases at an optimum temperature.

The term “customer” is used herein broadly and may mean, for example, any type of end-user.

### SUMMARY

A multi-temperature intelligent storage and retrieval system is disclosed to facilitate pick-up of orders by customers. The apparatus and methods disclosed are particularly applicable to online grocery ordering and unattended customer pick-up at grocery stores or warehouses. The term “unattended” includes fully unattended and partially unattended.

In an illustrative embodiment, a customer places an order that can be pre-picked from inventory, placed into totes, and stored in a multi-tiered, stacked carousel system, wherein one or more tiers are temperature controlled. Each carousel may have multiple bins, each holding multiple totes. Goods associated with an order can be placed into the totes manually or by an automated system, and sent to the carousel system for storage. The totes are automatically loaded and unloaded into the carousel.

A customer requests an order for pick-up. The totes associated with the order are automatically removed from the carousel and automatically delivered via a conveyor system or robot to an appropriate pick-up bay. Once the customer is at the pick-up bay, the totes are sequentially presented to the customer for product removal.

### DESCRIPTION OF DRAWINGS

The detailed description refers to the accompanying figures, which depict illustrative embodiments, and in which:

FIG. 1 depicts an automated storage, retrieval and pick-up system.

FIG. 2 illustrates how the automated storage, retrieval and pick-up system may be partitioned into a customer side and a vendor side.

FIG. 3 depicts a carousel structure with enclosed sides removed to show vertical bins, and totes positioned within the bins.

FIGS. 4A, 4B depict opposite ends of a carousel rotation apparatus that imparts rotational motion in a horizontal plane to carousels.

FIG. 5 depicts a carousel structure with a carousel inserter/extractor.

FIG. 6 is a close-up of an inserter/extractor apparatus.

FIG. 7 shows a tote being retrieved from a bin for transfer to a conveyance system.

FIG. 8 depicts a conveyance system.

FIG. 9 depicts a pick-up bay.

FIG. 10 is a cut-away view of a lifting apparatus.

FIGS. 11A, 11B, 11C, 11D depict a lifting apparatus and parts thereof for lifting a tote from the conveyance system and tilting it toward an opening in a pick-up bay countertop.

FIG. 12 is a flow chart of an empty tote inspection system.

FIG. 13 shows the flow of steps in an order placement procedure and induction into a carousel structure.

FIG. 14 is a flow chart of steps in a procedure for a customer picking up an order that is stored in carousel structure.

FIG. 15 depicts a schematic of a conventional warehouse management system.

FIG. 16 depicts the outside of a warehouse, retail outlet or other building from which groceries or other items may be picked up.

FIG. 17 is a block diagram of a computing device that is a component of the multi-temperature, automated storage, retrieval and pick-up system.

FIG. 18 depicts a communications architecture of a multi-temperature, automated storage, retrieval and customer pick-up apparatus.

FIG. 19 depicts a simplified schematic of an onboarding pole display.

FIG. 20 depicts a simplified schematic of a pick-up window display.

FIG. 21 provides a block diagram of various components of the multi-temperature, automated storage, retrieval and customer pick-up system.

### DETAILED DESCRIPTION OF EMBODIMENTS

The figures and descriptions provided herein may have been simplified to illustrate aspects that are relevant for an understanding of the described devices, systems, and methods, described herein while eliminating, for the purpose of clarity, other aspects that may be found in typical devices, systems, and methods. Those of ordinary skill may recognize that other elements or operations may be desirable or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that could be implemented by those of ordinary skill in the art.

An intelligent storage and retrieval system is provided that is capable of storing completed customer orders in totes, segregated by temperature requirements. Embodiments of the invention provide a completely, or near completely, touch-free customer pick-up experience. An integrated hardware and software system functions to implement the purchase and pick-up experience. Components may include, for example, storage carousels, conveyor systems, pick-up bays, robotic conveyance apparatuses, additional robotic devices, and other elements that are managed and functionally coordinated with one another by the software-implemented control system. A completely autonomous tote storage, retrieval and pick-up may be achieved. The automated system is particularly suitable for e-commerce applications.

The software controls carousels, conveyance apparatus, pick-up windows, carousel inserter/extractor and tote management functionalities. The software platform may route totes inbound on a conveyance system to one or more carousels for storage, and then retrieve totes from the carousels for routing to an appropriate pick-up bay. One or more user interfaces may be provided for customer interaction and utilities for supervisory personnel. The system can be configured with or without exchanging data with a host warehouse management system or other business systems.

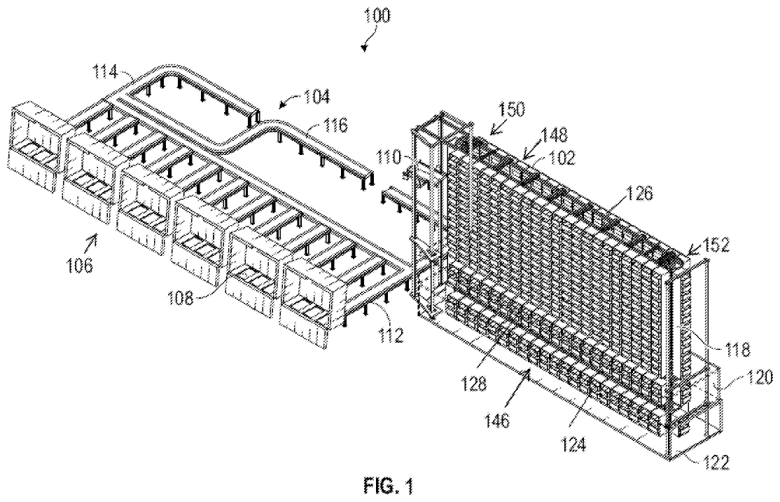

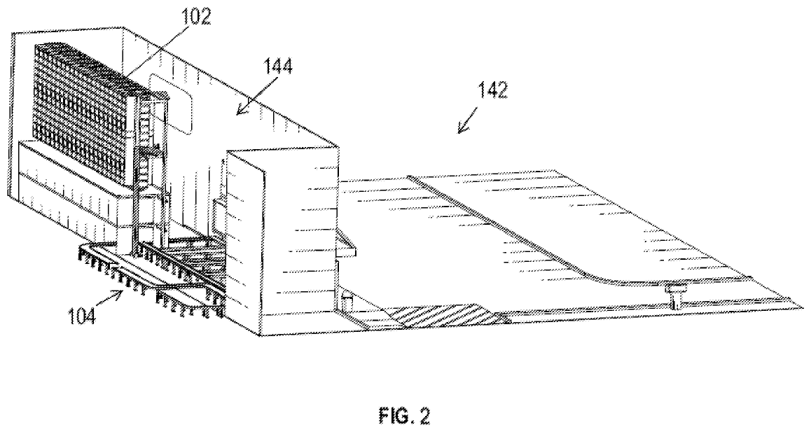

FIG. 1 depicts an automated storage, retrieval and pick-up system 100 that includes a storage carousel structure 102, a conveyance system 104 and a plurality of pick-up bays 106. FIG. 2 illustrates how the system may be partitioned into a customer side 142, which a customer may access pick-up bays 106, and a vendor side 144 containing carousel structure 102 and conveyance system 104. Automated system 100 may include a multi-temperature system that maintains items at a plurality of selected temperatures. This makes automated system 100 particularly applicable for use with food items such as groceries, but may also be used for pick-up of other items that need to be maintained at a particular temperature or in a particular temperature range. In an exemplary embodiment, automated system 100 is implemented as an unattended pick-up system.

Carousel structure 102 may be of any configuration that accommodates groceries or other items and can be coordinated with a conveyance system 104 and an automated inserter/extractor apparatus 110 to insert and extract goods or totes containing goods from carousel 102. Although inserter/extractor apparatus 110 is described herein, other automated order retrieval and placement systems may be used. Generally the automated order retrieval and placement systems are configured to place portions of a customer order in locations in the carousel structure according to one or more electronic codes associated with the order and retrieve the portions of the customer order from the positions in the carousel structure and deliver the portions of the customer order to the pick-up bay.

As used herein, “carousel structure 102” may include multiple carousels, independently operated, or may have a single carousel. Carousel structure 102 may be, for example, a high-density carousel. Conveyance of goods to pick-up bays 106 and directly to customers can also be made by autonomous robots. Automated system 100 may include multiple, tiered carousels. Examples of carousel configurations include, horizontal and vertical carousels and vertical lifts. Carousel structure 102 may be manually stocked or items may be placed in the apparatus by automated inserter/extractor 110, which may be connected to, or positioned to coordinate with, carousel structure 102 to load and retrieve items.

In an illustrative embodiment, carousel structure 102 may include one or more horizontal carousels consisting of a closed-loop horizontal track holding carriers (bins) 146, that provide automated storage and retrieval systems. In a horizontal storage system, such as depicted in 1, bins 146 are vertical columns in which multiple totes 115 are held in a stacked configuration. When activated, the bins of each carousel rotate to bring requested items to the conveyance system 104. In a further illustrative system, carousel structure 102 includes one or more vertical carousels with storage trays that dynamically respond to height sensors.

Carousel structure 102 may be configured with a range of standard tray and tote sizes, weight capacities, and vertical heights. In an illustrative embodiment, 10 totes 115, each 2 feet by 2 feet, fit along each parallel portion of transport section 112 of conveyance system 104, as shown for example, in FIG. 1.

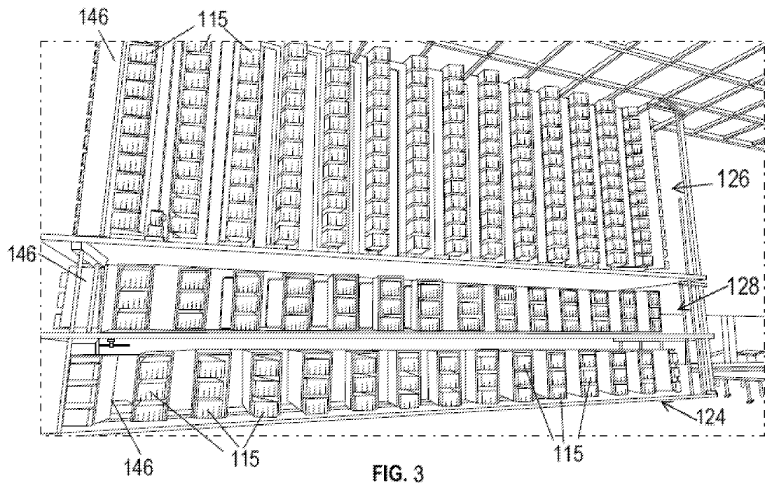

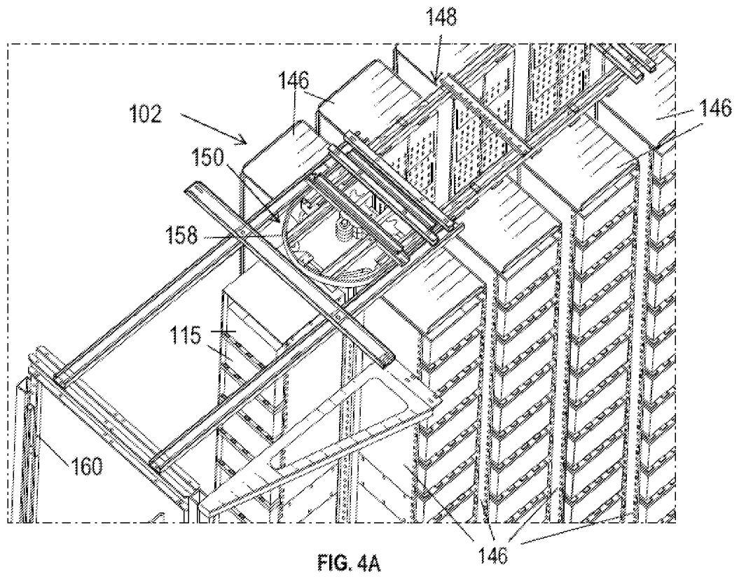

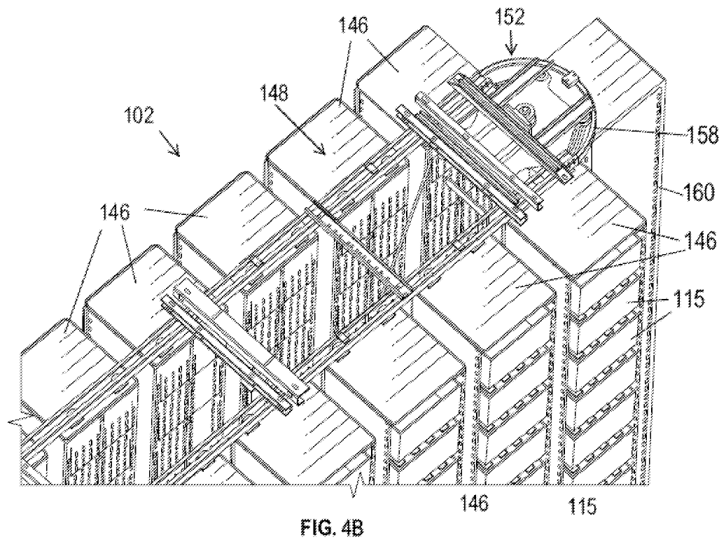

FIG. 3 depicts an illustrative embodiment of a carousel structure 102 with enclosed sides removed to show vertical bins 146, and totes 115 positioned within bins 146. The carousel structure depicted in FIG. 3 includes a bottom section having bins 146 containing three totes 115 each. A middle section also has bins 146 containing three totes 115 each. An upper section has bins 146 containing thirteen totes 115 each. Bins 146 rotate horizontally. Each horizontal carousel rotates independently. Enclosures may be provided around any of the tiers for temperature insulation and control. FIGS. 4A, 4B depict opposite ends 150, 152 of a carousel rotation apparatus 148, which imparts rotation in a horizontal plane to carousels in carousel structure 102. Rotation apparatus 148 of which portions are shown in FIGS. 4A, 4B can be seen more fully in FIG. 1. Each end 150, 152 has a motor coordinated to rotate bins 146 along an elongated oval track 158. Each carousel has a separate rotation apparatus 148. Each rotation apparatus 148 is controlled by a controller of automated system 100.

Each tote 115 may have an identification element such as a “license plate” or other identification (ID) component. The identification components may be read by suitable devices such as scanners. The ID component contains information coded by a software system and/or to be input to the software system to effectuate the pick-up service or any variation thereof. (It is noted that embodiments of the invention may not be entirely touch-free.) Examples of technology that can be used to code information associated with customer orders and conveyance to the customer include linear (1D) barcodes, or a 2D barcode, RFIDs or other identification components. Examples of information that can be contained in the identification component include order number/control number, bag identification (ID) or license plate number (LPN), and storage requirements, such as temperature. The QR (quick response) code is the code that is delivered to the customer by the vendor to ID the order in the customers system. The information in the QR code pertinent to the order storage and pick-up in the QR code is the order number. This code is used by the customer.

A QR format code, or other electronic code is used at induction of the order into the storage system comprising carousel structure 102. A vendor may be provided with the ability to divide contents of an order into temperature zones to facilitate organized picking. If the vendor has this ability, the code presented to the clerk at the induction point will contain both an order number and temperature requirements. If the vendor does not have this ability, the induction code will contain only the order number and the temperature requirement will need to be communicated in an alternate method.

A customer at pick-up can provide an order number or control number for tote retrieval. A tote 115 may hold items or bags of goods for the same customer order and the same storage zone, or multiple totes 115 may be used for a single order.

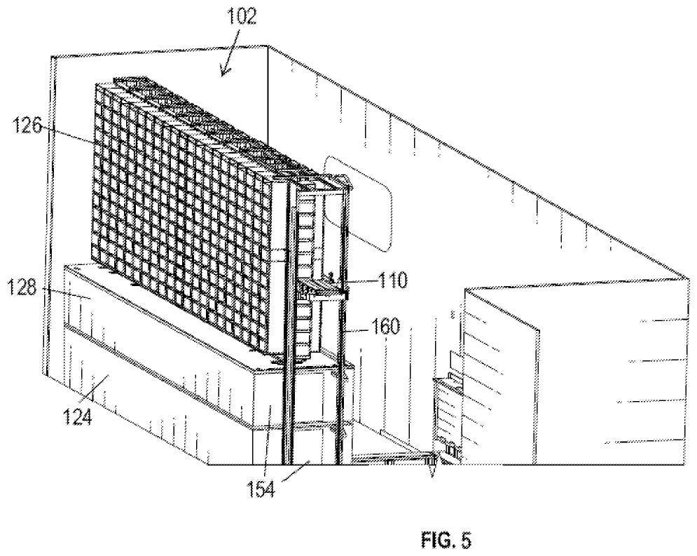

FIG. 5 depicts carousel structure 102 with carousel inserter/extractor 110 operable alongside of, and exterior to, carousel structure 102. Exterior positioning of carousel inserter/extractor 110 provides flexibility with regard to interfacing various components of automated system 100, such as between conveyance system 104 and carousel structure 102. Carousel inserter/extractor 110 travels vertically on rails 160 propelled by a motor integrated with automated system 100 software to coordinate insertion and extraction of totes 115 with customer pick-up and personnel loading operations. In upper, ambient carousel section 126, inserter/extractor 110 has direct access to toes 115. In temperature controlled sections 124, 128, inserter/extractor 110 accesses totes 115 through carousel access doors 154.

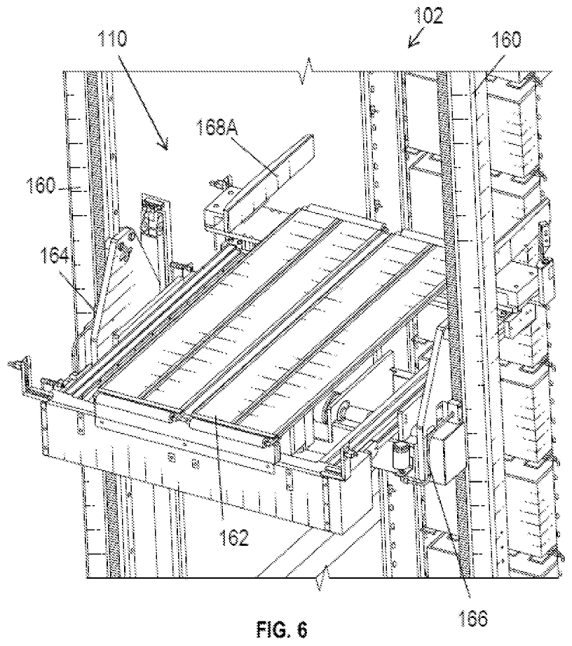

FIG. 6 is a close up of the inserter/extractor 110 shown in FIG. 5. Inserter/extractor 110 has a platform 162 onto which totes 115 are introduced, for example by an operator or an automated system. Platform 162 is then lifted via motors 164, 166 along rails 160 to a level indicated by automated system 100 for storage. The selected tote position may be based on the most efficient insertion and retrieval placement and the required temperature of the contents of tote 115. Platform 162 also travels vertically along rails 160 as directed by automated system 100 to retrieve totes 115 for delivery to pick-up bays 106 via conveyance system 104 for order pick-up by a customer.

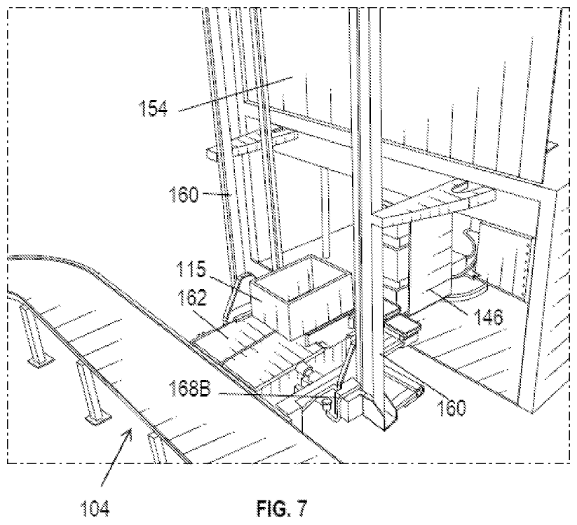

FIG. 7 shows a tote 115 being retrieved from bin 146 for transfer to conveyance system 104. Platform 162 or a portion thereof travels horizontally to retrieve or deliver totes 115 from or into bins 146. In the illustrative embodiment of FIGS. 6 and 7, a pair of grabbers or arms 168A, 168B that move in two perpendicular directions. Arms 168A, 168B move toward and away from carousel structure 102. When moved toward carousel structure 102 in position to retrieve tote 115, arms 168A, 168B move together to grasp tote 115. Once tote 115 is secure in inserter/extractor arms 168A, 168B, the arms move toward conveyance system 104. Once positioned on conveyance system transport section 112, arms 168A, 168B release tote 115. Platform 162 may have other mechanisms to transfer totes 115 to conveyance system 104, such as conveyor belts operable around platform 162, or platform 146 may be positioned between or on guides to allow it to travel into carousel structure 102 to retrieve bins 146, and travel away from carousel structure 102 to transfer bins to conveyance system 104.

Temperature control can be implemented within carousel structure 102. In an illustrative example, carousel structure 102 is a three temperature storage system that can deliver items to conveyance system 104. Totes 115 may be stored in the required temperature zones, such as temperature zones 118, 120, 122. The system may be configured to store totes 115 in locations to facilitate the fastest retrieval times. Storage and retrieval of totes 115 may be optimized by the carousel in each temperature zones rotating independently from one another, allowing the inserter/extractor to be in constant motion. Carousel structure 102 uses thermal isolation to create isothermal environments, such as for temperature zones 118, 120, 122 shown in FIGS. 1 and 3. Each temperature zone may be configured to maintain a temperature based on the type of items to be stored in the zone. This may be a temperature necessary or desired to properly maintain or preserve the items, such as according to industry standards. For example, the zones may provide freezer, refrigeration, and ambient segments. Illustrative temperatures include, for example, refrigerator temperature (for example, 34-40 degrees F.), freezer temperature (for example, negative 3 degrees to 1 degree F.) and ambient temperature or a cooled third temperature zone between 50 degrees to 70 degrees. Carousel structure 102 may be configured to maintain items at a number of different temperatures, meaning both the number of temperature options and the temperature of each of those options. Temperatures may be fixed or adjustable.

In an illustrative embodiment, such as shown in FIG. 1, a refrigerator section 124 is on the bottom of carousel structure 102, an ambient section 126 is on the top, and a freezer section 128 is positioned therebetween. Each of sections 124, 126, 128 includes an independently operated carousel. If the carousel sits on a cement slab, it will generally be easier to insulate the cement slab for refrigerated section 124 than it would be for freezer section 128. Each carousel in carousel structure 102 may be configured with dual AC motors running from a single variable frequency drive (VFD) to enhance efficiency. A temperature control unit(s) may be run on 230 VAC 3 phase power.

Refrigerated section 124 and freezer section 126 are housed in appropriate temperature control enclosures, or within a single, divided temperature controlled enclosure, with the internal temperature controlled by independent systems for each of sections 124, 126. Ambient temperature carousel may be unenclosed. Although only three temperature zones are presented in this embodiment, it is understood that additional, or different temperature zones may be employed. Any temperature zone to be maintained at other than ambient temperature will be enclosed in order to control the temperature. Since temperature zones 118, 120, 122 (or other temperature zones) need to be as thermally isolated as possible, carousels in sections 124, 126, 128 may be supported by the thermal enclosures.

Each of refrigerator section 124 and freezer section 128, or any other enclosed carousel structure section, will be equipped with automatic doors 154 that allow inserter/extractor 110 access to totes 115 as shown in FIG. 5. Carousel access doors may be for example, insulated doors that roll up or down to provide clearance for inserter/extractor 110 to retrieve and deliver totes 115.

Carousel structure 102 is configured to properly insulate temperature zones from one another to reduce or eliminate condensation or other problems that may arise at the interface of different temperature zones. Various thermal isolation components and configurations may be employed for this feature. For example, adequate spacing to inhibit or prevent condensation may be used. In addition or alternatively, heaters may be employed to reduce condensation. Various types of thermal insulating materials may also be employed to insulate the temperature zones or sections to maintain each at its desired temperature most efficiently. Automatic access doors 154 may add to the thermal isolation of each zone or section.

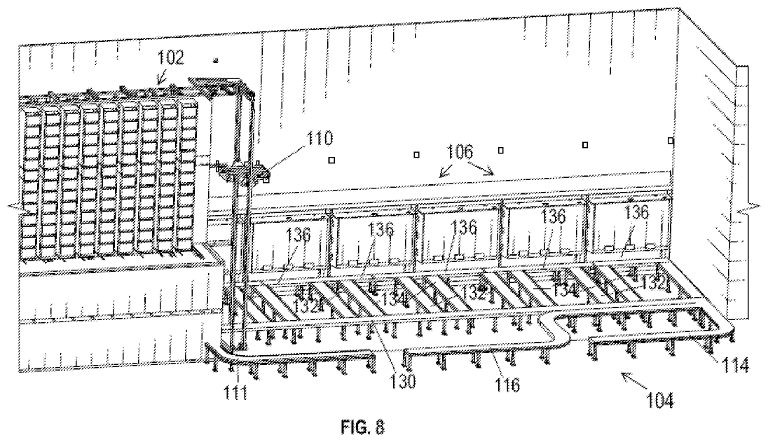

FIG. 8 depicts a conveyance system 104. Conveyance system 104 transports items from carousel structure 102 to pick-up bays 106. Conveyance system 104 may comprise, for example, a loading transport section 111, pick-up transport section 112 to direct items to pick-up bays 106, an empty tote transport section 114 for conveying empty totes 115 away from the pick-up area and a reject transport section 116 to move rejected totes 115 away from the pick-up area for further processing. The specific configuration of each of transport sections 112, 114, 116 may vary. Pick-up transport section 112 may include a main transport section 130, bay inbound transport sections 132, and bay outbound transport sections 134. Independent connecting transport sections 136 parallel to the rear wall of pick-up bays 106 may connect bay inbound transport sections 132 and bay outbound transport sections 134. Conveyance system 104 may be any transport system that enables the items to be moved to a desired location, for example conveyor belts, roller systems or autonomous robots. The specific configuration of the conveyance system may be dictated, for example, by the configuration of the site or the types of goods being transported. Conventional conveyance hardware and motors may be implemented in conveyance system 104. Cameras and other sensors are incorporated along conveyance system 104 to provide signals to control systems to guide and direct totes 115 to pick-up compartments 108 of pick-up bays 106, empty tote transport section 114 or reject transport section 116, for example.

The process may be fully automated or automated to varying extents, through use of appropriate software. For example, carousel structure 102 may be stocked either by hand or in an automated manner from other equipment. In a further embodiment, a merchant may fill orders by placing items or otherwise introducing items into totes 115 in carousel structure 102. The merchant may enter information into a computer system that directs carousel structure 102 and conveyance system 104 to move the items to a particular pick-up bay 106. In a further embodiment, a merchant's personnel retrieves items from carousel structure 102 to fill an order and then directs the combined order to a pick-up bay 106 through a software application or back into carousel structure 102 as an order for customer pick-up. As used herein “merchant” may be any party that is supplying the items that are being picked up. As used herein “customer” may be any party that is picking up items.

In a more fully automated system, a customer places an order online. Placement of the order causes the automated system 100 to deliver the purchased items to particular pick-up bay compartments 108 within a particular pick-up bay 106. The customer is automatically provided with information necessary to retrieve their order from pick-up bay 106. The automated system may keep track of the pick-up time of the order, and may flag orders that have not been picked up by a threshold amount of time. Once flagged, various actions may follow. For example, the customer may be alerted that their order was not picked up, or the order may be removed from the pick-up bay and returned to carousel structure 102 or elsewhere or directed to reject transport section 114. The software may be accessible via the Internet, or through a downloadable mobile application. Software applications may provide an interface with customers and/or merchants.

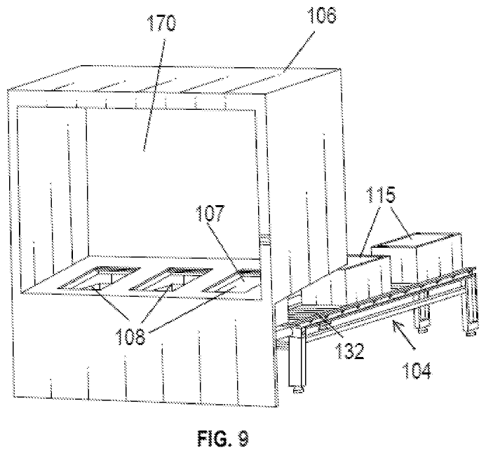

FIG. 9 depicts an illustrative embodiment of a pick-up bay 106. Pick-up bays 106 may have multiple pick-up bay compartments 108. Each pick-up bay compartment 108 may have a pick-up bay window or cover 107. For simplicity, all coverings of pick-up bay compartment 108 will be referred to as a pick-up bay window 107, whether clear or opaque, and whether flexible or rigid. Alternatively, a single pick-up bay window or cover may span the openings of all pick-up bay compartments 108 in a single pick-up bay 106. FIG. 9 shows the pick-up bay compartments 108 on the right with a closed cover 107. The other two pick-up bay compartments 108 are shown as being opened. Inbound transport section 132, which is a section of conveyance system 104, is shown at the rear of pick-up bay 106. Totes 115 are on inbound section 132 for delivery into one of pick-up bay compartments 108. A user interface 170 is behind pick-up bay compartments 108. A user may interact with the automated system 100 through user interface 170. This may include inputting information, or receiving messages.

Pick-up bay compartments 108 may be at ambient temperature or at a selected temperature if a temperature control system is incorporated into the bay. Alternatively, each compartment may be maintained at a different temperature. This allows foods or other items to be stored in the pick-up bays for extended periods of time at appropriate temperatures. The system may be configured to automatically direct items to the appropriate pick-up bay compartment, through software applications. For example, look-up tables within the software may associate products with specific temperature requirements. For example, a universal product code (UPC) can be associated with a particular temperature, and thus, a particular pick-up bay compartment or storage carousel zone. In practice though, to keep bays available for multiple customers, goods will be in pick-up bays 106 for only a short period of time, eliminating or reducing the need for temperature control.

In an illustrative system there are four to eight pick-up bays 106, each with three compartments 108. Goods in pick-up bays may tilt up for ease of retrieval.

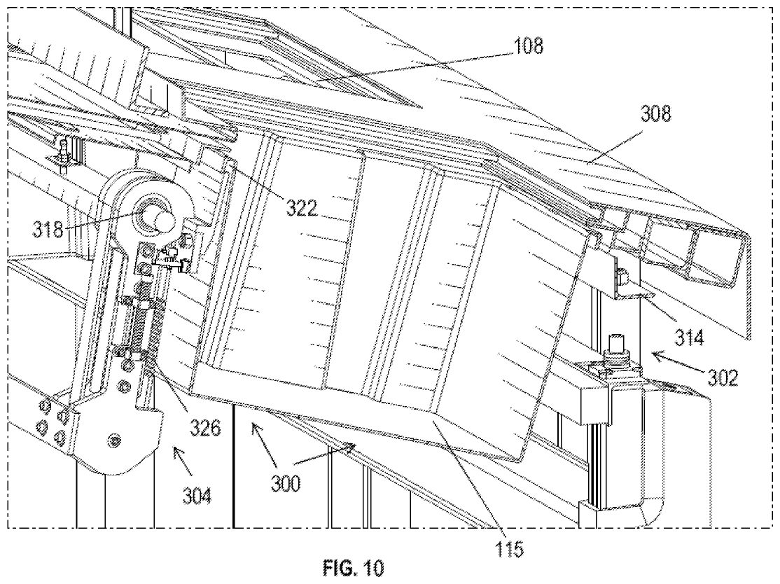

FIG. 10 is a cut-away view of a lifting apparatus 300. Lifting apparatus 300 tilts totes 115 to be flush or angled as desired with respect to the opening of pick-up bay compartments 108. Lifting apparatus may also be implemented for tilting other containers or objects from a surface. Lifting apparatus 300 has two lift mechanisms 302, 304 that work in tandem to lift tote 115 up and seal it to the countertop 308 of pick-up bay 106. Front lift mechanism 302 and rear lift mechanism 304 work in sync to lift and angle tote 115 up to the opening of pick-up bay compartment 108 creating an ergonomic position for the customer to take their items from.

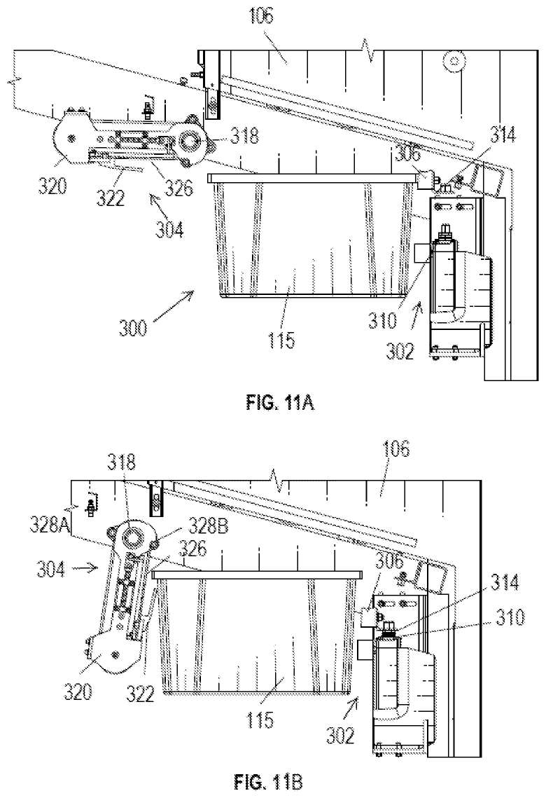

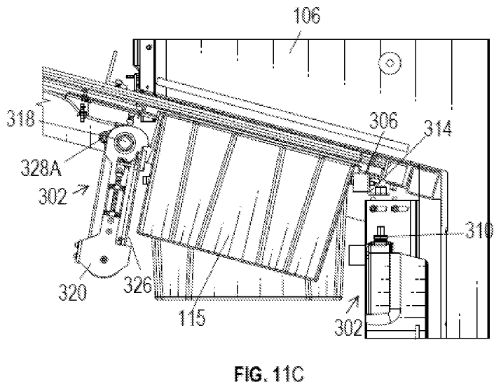

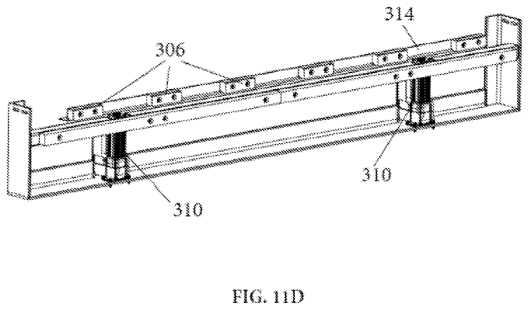

FIGS. 11A, 11B, 11C depict lifting apparatus 300 lifting tote 115 from connecting transport section 136 and tilting it toward an opening in countertop 308. FIG. 11D depicts a portion of front lift mechanism 302. Front lift mechanism 302 consists of two linear actuators 310 with a bar 314 that attaches them together. On bar 314 there are custom cut lift profiles 306 that match the shape of the tote to ensure a secure and snug fit when lifting and holding tote 115 up to the countertop 308. When a tote 115 is in position, linear actuators 310, 312 extend and lift tote 115 from transport section 136 to the desired height and hold tote 115 there for as long as needed. When tote 115 is ready to come down, the actuator slowly lowers tote 115 back to transport section 136 and then retracts even further so it is not in the way when tote 115 moves on transport section 136 or elsewhere.

As shown in FIG. 11A, rear lift mechanism 304 starts fully retracted, parallel to the floor so totes 115 can be moved on connecting transport section 136 of conveyance system 104 underneath them. Once totes 115 are in position, rear lift mechanism 304, which is powered by a motor controlled by a controller of automated system 100, begins to rotate down toward tote 115 on the main driveshaft 318 as shown in FIG. 11B. Once at the bottom of its swing, the body 320 of rear lift mechanism 304 stops. The main driveshaft 318 continues to rotate and now turns a toothed belt 326 on two pulleys 328A, 328B that are a part of rear lift mechanism 304. This toothed belt 326 has a custom built profile designed to catch the edge of tote 115. Once the profile catches the edge of tote 115, it raises the tote up and into final position in line with the angle of countertop 308. Once complete, pick-up window 107 opens and the customer takes their items. Lifting apparatus 300 is designed to not back drive so it will be able to hold tote 115 in position for as long as needed. When tote 115 is empty and pick-up window 107 has closed, rear lift mechanism 304 reverses the process from above, ending back at its starting position up and out of the way of tote 115 so it can pass underneath. A separate lifting apparatus 300 may be associated with each pick-up bay compartment 108, or a single lifting system may be configured to lift multiple totes 115 simultaneously within the same pick-up bay 106.

Pick-up windows 107 may be automatically actuated based on communication from the software prompted by the arrival of, and signaling by, the customer. Access doors may also be designed to be manually operated, for example by lifting or sliding a door on tracks or opening a door on hinges. Customer arrival is signaled, for example, using a touchless scanning mechanism such as a biometric, QR Code, phone scan, and retailer awards cards. Order completion is identified using software coordinated with a scanning or other sensing or other input mechanism of the storage area. Again, a touchless scanning mechanism, such as to detect a customer wave, or a non-touchless mechanism, such as entry of a selection on a screen may be used to complete the transaction.

In an illustrative embodiment, pick-up bay 106 has multiple pick-up bay compartments, for example three, and any of: audio and/or visual customer experience equipment, scanning equipment, such as a QR Code scanner, inspection cameras to detect when totes are empty, switches, such as one activated by a hand wave, safety light curtain, and an intercom for customer assistance.

The safety light curtain is to protect the customer from possible pinch points of pick-up windows 107. There may be one light curtain across all pick-up bay window 107 in a single pick-up bay 106. If the light curtain is interrupted during the closing process, pick-up bay window 107 will stop and reverse direction for a designated time, for example 0.5 seconds, then stop. Once the light curtain is clear, the window closing process will continue. The light curtain can be automatically reset. This control can be incorporated into a safety portion of the control system.

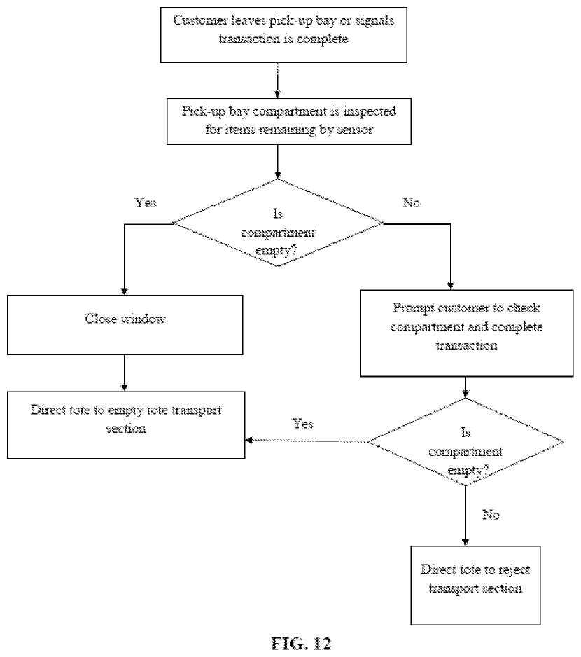

FIG. 12 is a flow chart of an empty tote inspection system, also referred to as a “vision system” and “vision inspection,” that may be incorporated into the automated system 100. One or more inspection cameras 140 may be positioned in or near the pick-up bays 106. Once a customer leaves the pick-up bay area, or signals that the transaction is complete, such as by a hand wave or providing input by other means or the system times out, the inspection camera 140 will send a signal to the controller indicating if the tote is not empty. This can be accomplished, for example, by an algorithm that analyzes an image from a camera to determine if a tote 115 is empty. Another means is a sensor that can detect whether a tote 115 is empty, such as by the time a signal takes to be transmitted and received upon reflection. If tote 115 passes an empty tote inspection, pick-up window 107 will close and tote 115 will be directed to the empty tote transport section 114, or otherwise directed out of the immediate areas of pick-up bay 106.

If tote 115 does not pass the empty tote inspection, the customer will be prompted to recheck the totes and reactivate the order completion switch. If the tote still does not pass the empty tote inspection after re-inspection, pick-up bay window 107 will close and tote 115 will be routed to a reject station via reject transport section 116 for disposition assignment.

If it is detected that the customer has left the area and the system times out, there will be no retest sequence. The tote will be inspected once and routed to the reject area if it does not pass the empty tote inspection. The system is considered to have timed out if a threshold time of inactivity has been reached. In activity may be determined by motion sensors or by lack of response, input or action from a customer. Once the time threshold has been reached the system will end the transaction and if the pick-up bay or pick-up bay window is open, the system will close it.

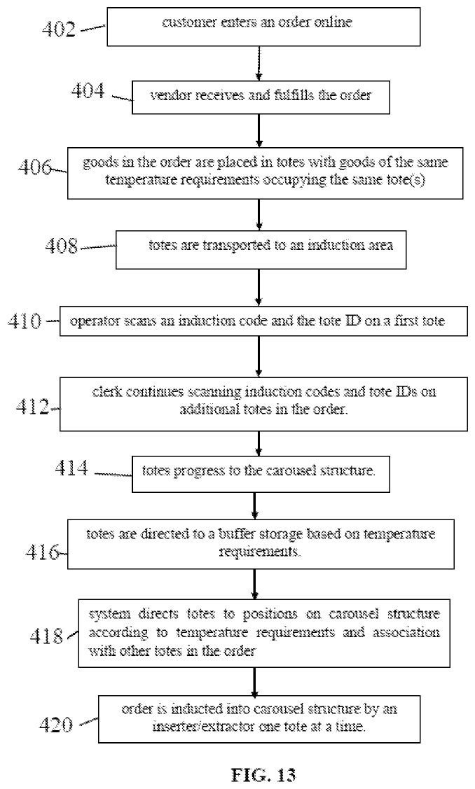

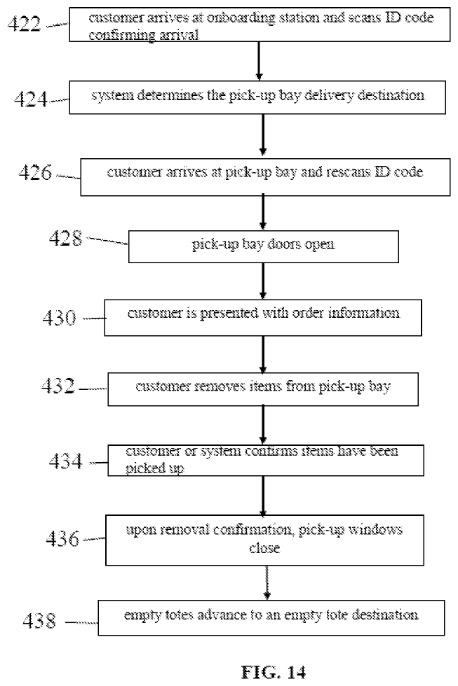

In an illustrative embodiment, totes 115 are all the same color to simplify the vision inspection application used for empty tote inspection. FIGS. 13 and 14 are flowcharts of an illustrative embodiment of a consumer order and pick-up process carried out using, for example, a personal computer and/or a mobile handheld device. FIG. 13 shows the flow of order placement and induction into carousel structure 102. FIG. 14 shows the steps associated with a customer picking up an order that is stored in carousel structure 102. Customer interaction may be via a browser based application or a software application downloadable to a personal device, such as an iPhone.

In step 402 the customer enters an order online via the vendor's proprietary app or website. In step 404 the vendor receives the order and fulfills the order using an automated order filling system or by manually gathering items in the order. The order is fulfilled by placing ordered items in a tote 115 or other receptacle, such as a as a bag or box in step 406. If the storage requirement for an item or bag is the same as a prior item or bag in the same customer order, the system will prompt the operator to scan the tote ID destined for the same storage area of the carousel. If the storage requirement is different, the system will prompt the operator to scan a new tote ID. In step 408 a customer's order is then transported to an induction area on the vendor side 144 of a wall. The order may arrive in a tote, or if in other containers, be placed in a tote 115, which may be any receptacle compatible with storage carousel structure 102. A completed customer order arrives to an induction area, such as at loading transport section 111.

Totes 115 have an ID component, such as a smart barcode. In step 410 the system prompts for entry of a tote ID (also referred to as an LPN). An operator scans the ID component, on the first tote 115 containing the customer's order or a portion thereof. Each tote 115 will have a storage requirement, such as a particular temperature zone. In step 412 an operator scans another tote in the customer order An operator scans the remaining totes in the customer order until complete. In step 414 totes progress to carousel structure 102 via loading transport section 111.

In step 416 the totes are directed to a buffer storage based on temperature requirements. In step 418 a put away algorithm finds the optimal storage location in the associated carousel to increase efficiency of the retrieval process. The order is then inducted into carousel structure 102 by inserter/extractor 110, one tote at a time in step 420.

Turning now to the flowchart of FIG. 14, in step 422, once the order is ready for pickup and the customer arrives on site for pick-up, the customer stops at an onboarding station and scans their QR code, smart barcode or other ID component from, for example, an email, app or printout at a first scan point, such as along a driveway/path. A geolocation system may also be used to automatically recognize the customer is arriving at the location. In step 424 the system determines the delivery destination (pick-up bay 1, 2, 3, etc.) based on the current queue of customers and totes to be delivered. The destination bay for the customer order is then displayed. If all pick-up bays are occupied, the customer is requested to wait at an onboarding pole or other designated area. Once a pick-up bay is vacant, the system instructs the customer to proceed to a particular pick-up bay, or the next available pick-up bay, and the system starts retrieving the order from the storage carousel(s).

In step 426, once at the pick-up bay, the customer rescans the ID component code to verify that the proper customer is present. Other authentication mechanism may be used to assure the individual is the authorized customer. If the customer has bypassed the onboarding station and goes directly to a pick-up window, this scan would also trigger the system to start retrieving the order from the storage carousel(s). A customer may only be prompted to scan the ID component when the totes are ready in a delivery area, which may for example be in the vicinity of a portion of pick-up transport section 112. In step 428 the customer scans the ID component and doors open revealing the totes containing the customer's order.

In step 430 the system will then present the customer with up to three totes (or how ever may compartments a bay is outfitted with) depending on order size. A monitor or other user interface at the pick-up bay will indicate to the customer how many totes the order contains, how many have been delivered, and how many are still in the system. If there are more totes in the order, the system presents the next group of totes to the customer.

Once the customer has removed their items in step 432, the customer confirms that they have removed their items by signaling the system, such by a hand-wave to activate a switch at the pick-up location in step 434. If the customer leaves that area without signaling (such as by a hand wave or other input) that the order has been removed, the system will timeout. The time remaining before the timeout period ends will be indicated on the monitor at the pick-up bay.

There is an option for vision inspection of an empty tote that may or may not be installed. When a customer removes their order, data from cameras and sensors determines whether the totes are empty and the system advances additional totes belonging to the order if any, and closes the pick-up bay doors when all totes have been returned.

In step 436, upon removal confirmation either by the customer or through system sensors/cameras, the pick-up windows 107 close.

In step 438 empty totes 115 advance to an empty tote destination along empty tote transport section 114 of conveyance system 104.

In illustrative variations of the process, either the operator signals the system when the tote is full or there is a limit to the number of bags or items per tote, for example two bags per tote, or a limit to the load weight for a tote. The number of bags per tote or weight limit may depend at least in part on the type of items that the system is handling and the size and construction of the totes. Two bags per tote may be suitable for groceries, whereas fewer or more bags per tote may be appropriate for other products. In a particular embodiment, this is the last human tote interaction for inbound tasks.

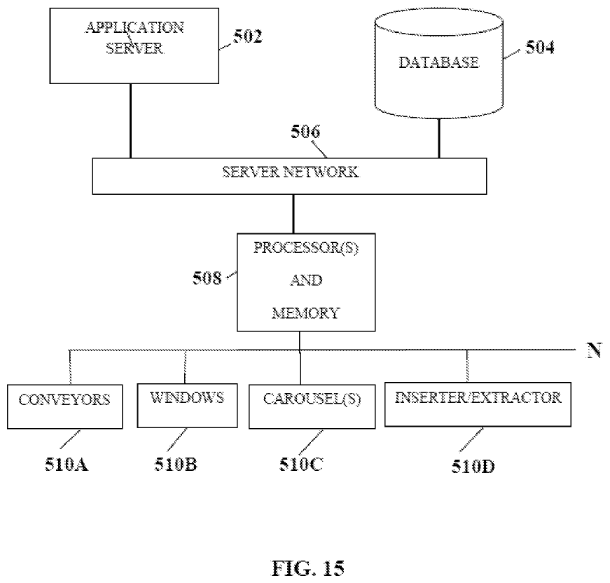

The system may be interfaced with various software applications, including for example, a warehouse management system (WMS) for further automation and inventory management, for example. The WMS may manage the flow of material inbound to a facility, route material inside the facility, and fulfill outbound requests for items. FIG. 15 depicts a schematic of a conventional WMS. An application server 502 and a database 504 are connected to a server network 506. Applications that control inventory management, routing and tracking, manage orders, utilize barcode and QR code scanning, among other functions, are executed by processors 508. Memory required for execution of the applications that can store algorithms and data is also represented in block 508. WMS may include management of storage carousels, conveyance systems, windows and inserter/extractor in blocks 510A-D plus “N”.

The WMS may send a tote ID, storage requirement and order number to a software application on the application server 502. When the tote ID passes an inline scanner at induction, the remainder of the process requires no human intervention. If no record of the tote is in the system, the tote is sent to a reject bin. The system may also be integrated with various types of warehouse execution software (WES) applications and warehouse control software (WCS) applications, or may have these functions directly incorporated into automated system 100. Warehouse execution software may include algorithms that optimize and manage various subsystems or directly manage activities such as order picking, mobile robots and inventory replenishment. Warehouse control software may direct activities within warehouses and distribution centers in real-time or over time. WCS and WES applications may maximize efficiency.

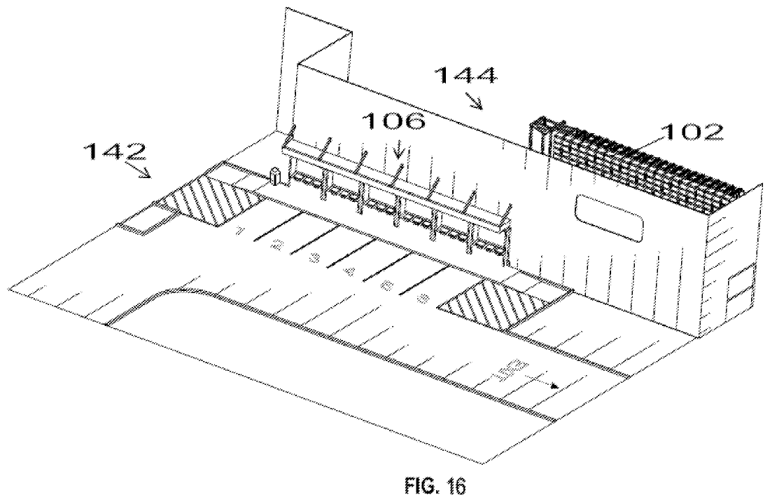

FIG. 16 depicts the outside of a warehouse, retail outlet or other building from which groceries or other items may be picked up. The exterior of pick-up bays 106 is shown from which customers may obtain their purchases. FIG. 8 shows an illustrative is an interior view of the building of FIG. 16, which shows pick-up bays 106 and carousel structure 102. More generally, automated system 100 will have two distinct sides. In the illustrative embodiments described herein, there is a customer side 142 and a vendor side 144. Customer side 142 is the side on which a customer, such as a purchaser of goods, interacts with automated system 100. Carousel structure 102 and conveyance system 104 reside on vendor side 144. Vendor side 144 may be adjacent to or include retail or warehouse space from which goods handled by automated system 100 are obtained.

Customer side 142 and vendor side 144 may be entirely open, entirely closed, or partially closed such as being a covered port. For example, in a grocery pick-up setting, vendor side 144 may be an enclosed space and customer side 142 may be entirely open. In this illustrative embodiment, customer side 142 may be partially covered to shield customers from environmental elements when exiting their vehicle to retrieve groceries from pick-up bays 106. Customer side 142 could also be within a parking garage, or other fully enclosed structure.

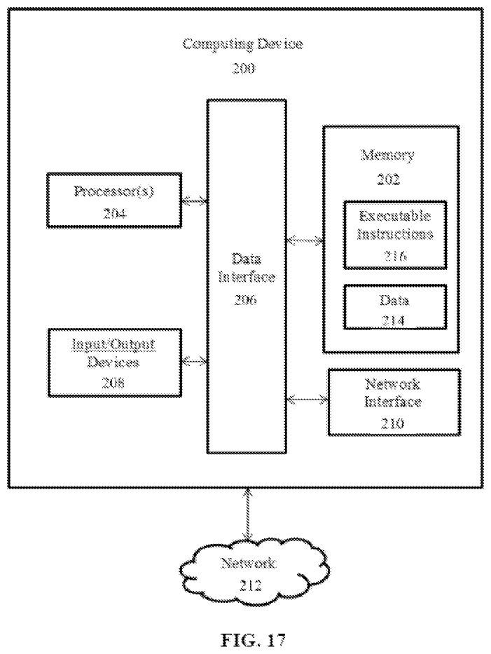

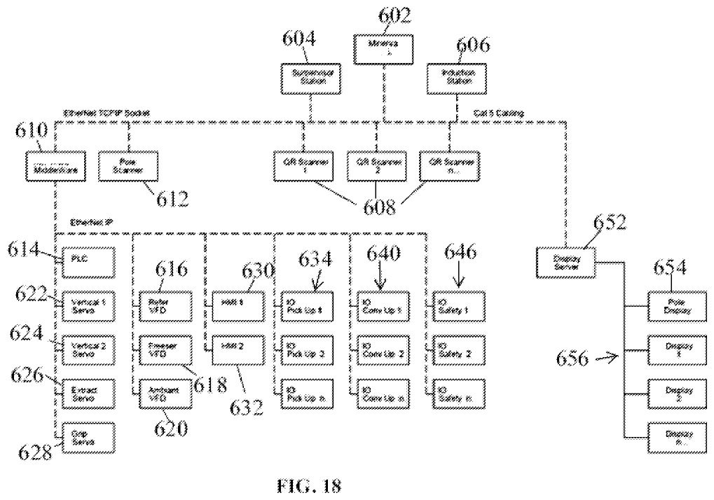

FIG. 17 is a block diagram of an illustrative embodiment of a computing device 200 that is a component of automated system 100. Computing device 200 comprises a memory device 202 that may be a single memory device or multiple devices for storing executable code 216 to implement any portion of utilizing automated storage and retrieval system 100 to store, maintain, retrieve, transport, house and release items for pick-up, including algorithms, for example to inventory items for an order and determine at what temperature they should be maintained in carousel structure 102 in which bin location orders should be stored or to which pick-up bay compartments 108 they should be directed. Further contained in memory device 202 may be stored data 214, for example temperature requirements for items, customer information, payment information, etc. One or more processors 204 are coupled to memory device 202 by a data interface 206. Processor 204 may be any device(s) configured to execute one or more applications and analyze and process data according to methods used to employ automated system 100 for its intended use. Processor 204 may be a single processor or a plurality of processors acting individually or in unison. Processor 204 may be, for example, a microprocessor, an application specific processor, or other device that may process and transform electronic data. Processor 204 executes the instructions stored on memory device 202. Memory device 202 may be integrated with processor 204 or be a separate device. Illustrative types and features of memory device 202 include volatile and/or non-volatile memory. Various types of memory may be used, provided the type(s) are compatible with the system and its functions. Illustrative examples of memory types include, but are not limited to, various types of random access memory, static random access memory, read only memory, magnetic disk storage devices, optical storage media, and flash memory devices.

Input/output devices 208 are coupled to data interface 206. This may include image capture devices, scanners, actuators, keyboards and/or touch screens, for example. A network interface 210 is also shown coupled to data interface 206, which may couple the computing device components to a private or public network 212.

FIG. 18 depicts an illustrative embodiment of a communications architecture of a multi-temperature, automated storage, retrieval and customer pick-up apparatus 100. Block 602 depicts software associated with automated system 100 that provides functionality such as inventory control, customer experience, data management, tote destination management, and supervisory system software automated system 100. Block 604 represents a supervisor station from which an operator can interface with automated system 100 and its software and hard components. Block 606 represents an induction station where an operator coordinates and inducts goods into automated system 100 including into carousel structure 102. Software applications in block 602 control induction of totes into the system. A plurality of QR scanners or shown in blocks 608. QR scanners may be used, for example, to obtain order information by an operator, allow a customer to initiate and end a pick-up process. Software applications in block 602 interface with QR code scanners.

Software applications communicate to middleware represented in block 610, for example, via TCP/IP messaging. The middle ware translates the data to and from a programmable logic controller (PLC) in block 614. The software application(s) of block 602 message to and from the PLC to ensure proper tote storage and delivery to pick-up bays and other locations along conveyance system 104 and within carousel structure 102. Block 612 represents a pole scanner that may scan a QR code presented by a customer when initiating the pick-up process. A pole scanner can also be any interface through which a customer may communicate with automated system 100 to initiate pick-up steps.

Middleware from block 610 is linked to the PLC through an Ethernet IP connection. An Ethernet connection further links middleware from block 610 to variable frequency drives (VFD) 616, 618, 620 for refrigerator section 124, freezer section 128 and ambient section 126, respectively.

Middleware from block 610 is also connected to a servo motor 622 to operate a refrigerator section carousel and a servo motor 624 to operate a freezer section carousel. Additional servo motors may be incorporated to operate additional carousels.

Further connected to block 610 is a servo motor represented in block 626 to operate inserter/extractor 110, which inserts totes into carousels in carousel structure 102 and removes totes from carousels in carousel structure 102. Travel of inerter/extractor 110 requires one or more motors to travel vertically to totes housed at different levels in carousel structure 102.

Block 628 represent a servo motor to operate a gripper that is a component of inserter/extractor 110. Motors provide movement of gripper arms toward and away from carousel structure 102, and movement of opposing arms toward one another to grip totes or items stored in carousel structure 102.

Blocks 630 and 632 represent human-machine interfaces for operation and use of automated system 100. For example, operators may interface with the system when scanning order information and during inductions actions. Customers may interface with the system at a pole display when entering a pick-up site, and at a pick-up bay.

Multiple blocks representing input-output devices are shown. These may include, for example, scanners for, touch screens, touchless devices for registering input from a user and outputting signals to the system. Shown are input/output devices associated with customer pick-up in blocks 634; input/output devices associated with conveyance system 104 in blocks 640 and input/output devices 646 associated with safety mechanisms, such as safety curtains. Any number of input/output devices with in these categories and others may by incorporated in automated system 100.

A display server is provided in block 652 that coordinates with various displays in automated system 100. This may include a pole display 654, pick-up bay display and other displays 656. Consumer massage displays may be part of the controls layer. Messages may originate from software applications 602 or from middleware 610.

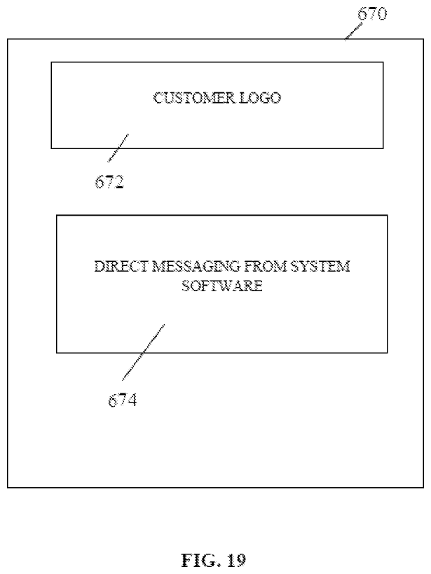

FIG. 19 depicts a simplified schematic of an onboarding pole display 670 according to an illustrative embodiment. Display 670 includes a section for a vendor's logo in area 672. Direct messaging from system software can be displayed in area 674. Area 674 may be divided into additional sections. Furthermore, other areas may be designated for various types of information or messages, including for example advertising and alerts.

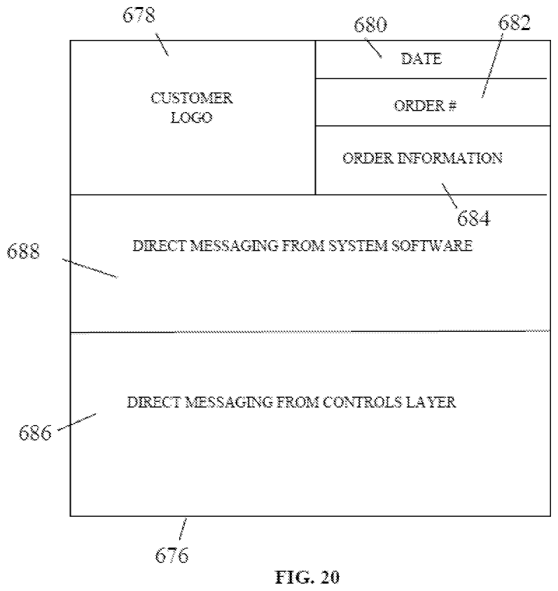

FIG. 20 depicts a simplified schematic of a pick-up window display 676. Pick-up window display 676 may include an area 678 for a vendor's logo, an area 680 to display the date, an area 682 to display an order number, and an area 684 to provide additional order information, such as the number of totes. Display 686 may also provide direct messaging from system software in area 686 and direct messaging from controls layer in area 688. It will be understood that this is merely an illustrative embodiment. Different layouts and different types of information may be displayed on display 676. Additionally, information need not all be displayed simultaneously on a single screen.

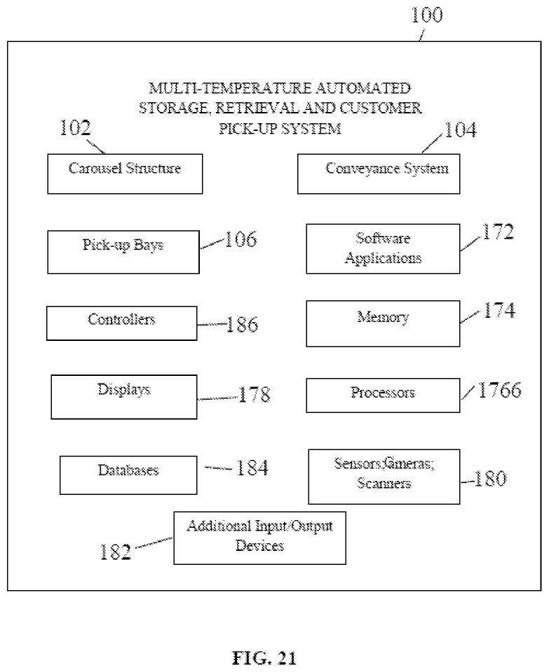

FIG. 21 provides a block diagram of various components of the multi-temperature, automated storage, retrieval and customer pick-up system 100. The primary structural components are carousel structure 102, conveyer system 104 and pick-up bays 106. Automated system 100 further includes software and hardware components to coordinate transporting, storing and delivering goods. This may include software applications represented in block 172, memory represented in block 174 and processors represented in block 176. Hardware components may also include displays in block 178, and as represented in block 180 sensors, including cameras and scanners and other devices that obtain information and data necessary to carry out the functions of automated system 100. Block 182 represents other input/output devices, which may include, for example, keyboards, hand-wave sensors, QR code readers and barcode readers. Databases are represented in block 184, which may contain information input into the system and information acquired through operation of the system. Block 186 represents various control devices and software. This covers a wide range of devices and software, which may be represented by other blocks in FIG. 21. The following functions of the automated system 100 are controlled by various algorithms in conjunction with hardware components: carousel structure 102, including temperature, movement, access ports, and placement of totes for storage, conveyance control associated with conveyance 104, pick-up bay components and functionality, such as movement of pick-up bay windows, tote tilt/lifting apparatus, safety curtain, customer authentication, empty tote vision inspection, inserter/extractor apparatus and user interfaces.

The invention includes various embodiments of the multi-temperature, automated storage, retrieval and customer pick-up apparatus, methods for employing the multi-temperature, automated storage, retrieval and customer pick-up apparatus, a user interface for the aforementioned apparatus and methods, and a non-transitory computer-readable medium having software code stored thereon, which when executed carries out any of the aforementioned methods. The invention further includes a lifting apparatus 300 that may be incorporated into automated system 100 or other structures or systems that benefit from the tilting operation provided by lifting apparatus 300.

Various embodiments of the invention have been described, each having a different combination of elements. The invention is not limited to the specific embodiments disclosed, and may include different combinations of the elements disclosed, omission of some elements or the replacement of elements by the equivalents of such structures.

The invention in its broader aspects is not limited to specific details shown and described herein. Modifications, for example, to dimensions, temperatures and types of items and users, and incorporation of equivalent components and steps, may be made without departing from the spirit and scope of the invention. Accordingly, it is intended that the invention not be limited to the specific illustrative embodiments, but be interpreted within the full spirit and scope of the appended claims and their equivalents.

1. A multi-temperature, intelligent storage and retrieval system comprising:
a carousel structure comprising a plurality of storage carousels wherein at least two of the plurality of storage carousels are in different temperature zones from one another;
a storage carousel controller configured to control each of the plurality of storage carousels in the carousel structure;
a conveyance system configured to transport items to the carousel structure and receive items from the carousel structure;
an automated order retrieval and placement system configured to place portions of a customer order in locations in the carousel structure according to one or more electronic codes associated with the order;
a pick-up bay configured to hold contents of the customer order and allow pick-up by the customer;
the automated order retrieval and placement system further configured to retrieve the portions of the customer order from the positions in the carousel structure and deliver the portions of the customer order to the pick-up bay.

2. The system of claim 1 comprising:
an electronic code containing information associated with the customer order, including in which temperature zone portions of the customer order should be placed in the carousel structure;
a reader to read the electronic code and send a signal to the storage carousel controller; and
the storage carousel controller configured to identify positions in the carousel in which items in the order should be placed based on the electronic code.

3. The system of claim 1 wherein the temperature zones include, an ambient temperature zone, a freezer temperature zone and a refrigerator temperature zone.

4. The system of claim 1 wherein the automated retrieval and placement system comprises:
an inserter/extractor apparatus configured to insert the customer order into the locations in the storage carousels according to the electronic code and retrieve the customer order from those locations.

5. The system of claim 4 wherein the inserter/extractor is exterior to the carousel structure.

6. The system of claim 2 wherein the conveyance system comprises:
a plurality of conveyor belts configured to transport customer orders to the carousel structure from an induction area and from the carousel structure to the pick-up bay based on the electronic code associated with the customer order;
a plurality of sensors configured to provide signals to a conveyance controller to guide and direct customer orders along the conveyance system.

7. The system of claim one configured to be touchless by the customer.

8. The system of claim 1 further comprising a vision system having a sensor and configured to senses whether a customer has removed the customer order from a tote.

9. The system of claim 1 further comprising a lifting apparatus configured to tilt a tote toward a pick-up window in a pick-up bay.

10. The system of claim 9 wherein the lifting apparatus comprises:
a front tilt apparatus and a rear tilt apparatus configured to work in tandem to angle and lift the tote up to an opening in a countertop in the pick-up bay.

11. The system of claim 1 wherein the plurality of storage carousels includes one or more horizontal carousels having a closed-loop horizontal track.

12. The system of claim 1 further comprising a time out system configured to end a customer order transaction after a threshold time of inactivity.

13. A method of automating purchases in a system having, a multi-temperature carousel structure, a conveyance system and pick-up bays, the method comprising:
obtaining an order electronically from a customer for one or more items wherein the order is associated with an order number and the order number is associated with an electronic code;
compiling the order and placing the order in one or more totes, each tote having an electronic code that identifies the one or more totes;
entering the order number into a computer system;
associating the order number with the one or more totes by scanning the electronic code of each of the one or more totes;
identifying in the computer system temperature zones in which each of the one or more totes should be stored;
automatically inducting the one or more totes into the temperature zone of the carousel structure associated with each of the one or more totes; and
upon entry by the customer of the electronic code, extracting the order from the carousel structure and transporting the items by the conveyance system to a pick-up bay based on the electronic code.

14. The method of claim 13 further comprising:
receiving from a sensor an input signal indicating that the customer has arrived at the pick-up bay; and
providing to the customer access to a compartment containing the one or more totes.

15. The method of claim 14 further comprising:
receiving a signal that the customer has removed the order from the one or more totes;
automatically inspecting the one or more totes by a sensor;
receiving by the system a signal specifying whether the one or more totes are empty; and
based on the signal received by the system, directing totes to an empty tote transport section of the conveyance system if specified as empty.

16. The method of claim 15 further comprising based on the signal received by the system, prompting the customer to check one or more totes specified as not being empty.

17. The method of claim 14 further comprising removing access to the pick-up bay absent activity for a threshold amount of time.

18. A non-transitory computer-readable medium on which is stored computer code, which when executed on one or more processors causes a computer system to perform the method of claim 13.

19. A lifting apparatus for tilting a container comprising:
a front tilt apparatus and a rear tilt apparatus configured to work in tandem to angle and lift an object from a surface.
